(19) United States
(12) Patent Application Publication
(10) Pub. No.: US 2024/0426700 A1
(43) Pub. Date: Dec. 26, 2024

(54) METHOD AND SYSTEM FOR PERFORMING CLEAVE ANGLE METROLOGY FOR AN OPTICAL FIBER

(71) Applicant: RAM Photonics Industrial, LLC, Webster, NY (US)

(72) Inventor: Joseph Lawson, Rochester, NY (US)

(73) Assignee: RAM Photonics Industrial, LLC, Webster, NY (US)

(21) Appl. No.: 18/749,338

(22) Filed: Jun. 20, 2024

Related U.S. Application Data
(60) Provisional application No. 63/522,058, filed on Jun. 20, 2023.

(51) Int. Cl. G01M 11/02; G01M 11/00

(52) U.S. Cl. CPC G01M 11/025; G01M 11/0214; G01M 11/0257; G01M 11/33

(57) ABSTRACT

A system for measuring a cleave angle of an optical fiber includes a light source configured to emit light and an optical fiber having a proximal tip, a distal tip, and a longitudinal axis. The optical fiber receives the light emitted by the light source at the proximal tip and emits characterization light from the distal tip. The system includes a first camera facing toward the optical fiber. The first camera measures a first position of the distal tip and a first angle corresponding to the longitudinal axis. The system includes a second camera facing toward the optical fiber, wherein the second camera measures a second position of the distal tip and a second angle corresponding to the longitudinal axis. The system also includes a position sensing device operable to measure the characterization light emitted from the distal tip.

### CROSS-REFERENCES TO RELATED APPLICATIONS

This application claims the benefit of priority to U.S. Provisional Patent Application No. 63/522,058, filed Jun. 20, 2023, entitled “METHOD AND SYSTEM FOR PERFORMING CLEAVE ANGLE METROLOGY FOR AN OPTICAL FIBER,” the entire contents of which is hereby incorporated by reference for all purposes.

### BACKGROUND OF THE INVENTION

Optical fibers have structures that support propagation of light by way of total internal reflection. When optical fibers are spliced together or bonded to optical elements, the fibers may be positioned and aligned for splicing and bonding. During the alignment process it is generally important to align the fiber such that light emitted by the optical fiber is minimally offset with respect to a corresponding end component. For example, a cleave angle of a cleaved end of an optical fiber may impact the offset or orientation of light emitted by the optical fiber. Any offset in the emitted light may impact the performance of the optical fiber in an optical system. Conventional cleave angle measurement systems and techniques are often unable to measure the cleave angle to within a degree of angle and often have minimal repeatability. Accordingly, despite the progress made in the development of cleave angle measurement systems and techniques, there is a need in the art for improved methods and systems related to measuring the cleave angle of an optical fiber.

### SUMMARY OF THE INVENTION

The present disclosure relates generally to methods and systems related to optical systems including optical fibers. More particularly, embodiments of the present invention provide methods and systems that can be used to measure a cleave angle of an optical fiber. The disclosure is applicable to a variety of applications in lasers and optics, including fiber laser implementations.

According to one embodiment of the present disclosure, a system for measuring a cleave angle of an optical fiber includes a light source configured to emit light and an optical fiber having a proximal tip, a distal tip, and a longitudinal axis. The optical fiber receives the light emitted by the light source at the proximal tip and emits characterization light from the distal tip. The system includes a first camera facing toward the optical fiber. The first camera measures a first position of the distal tip and a first angle corresponding to the longitudinal axis. The system includes a second camera facing toward the optical fiber, wherein the second camera measures a second position of the distal tip and a second angle corresponding to the longitudinal axis. The system also includes a position sensing device operable to measure the characterization light emitted from the distal tip.

The system may include various optional embodiments. The first camera may be disposed along a direction that is orthogonal to the longitudinal axis. The second camera may be disposed along a direction that is orthogonal to the longitudinal axis. The first camera and the second camera may be disposed in directions that are orthogonal to the longitudinal axis and the first camera is disposed along a direction that is orthogonal to the second camera. The system may include a first backlight disposed opposite the first camera and operable to illuminate at least the distal tip of the optical fiber. The system may include a second backlight disposed opposite the second camera and operable to illuminate at least the distal tip of the optical fiber. The system may include an optical fiber chuck configured to support the optical fiber. The optical fiber chuck may include a mechanical clamp or a vacuum clamp.

According to another embodiment of the present disclosure, a method for measuring a cleave angle of an optical fiber includes providing an optical fiber having a longitudinal axis and a distal tip characterized by a cleave angle, imaging the distal tip of the optical fiber, and determining, based on the imaging, a pose of the distal tip of the optical fiber. The method further includes emitting light from a light source. The optical fiber receives the light emitted by the light source. The method also includes emitting characterization light from the distal tip of the optical fiber, detecting, at an image sensor, the characterization light, and determining, based on the characterization light and the pose of the distal tip of the optical fiber, the cleave angle of the optical fiber.

The method may include various optional embodiments. The method may further include an optical fiber chuck that supports the optical fiber. The method may also include determining the pose of the optical fiber by translating the optical fiber chuck and the optical fiber along the longitudinal axis. Translating may include displacing the optical fiber along the longitudinal axis. The pose of the distal tip of the optical fiber may include a position and angle. The imaging may be performed by a first camera and a second camera. The first camera and the second camera may be disposed in directions that are orthogonal to the longitudinal axis. The first camera may measure a first position of the distal tip and a first angle corresponding to the longitudinal axis. The second camera may measure a second position of the distal tip and a second angle corresponding to the longitudinal axis. The first camera may be disposed along a direction that is orthogonal to the second camera. The image sensor may be a camera or a quadrant photodiode. The method may include detecting, at the image sensor, the characterization light. Detecting may include determining a position of the characterization light. The method may include illuminating the distal tip via a first backlight disposed opposite the first camera and a second backlight disposed opposite the second camera.

According to one embodiment of the present disclosure, a system for measuring a cleave angle of an optical fiber includes a light source configured to emit light and an optical fiber having a proximal tip, a distal tip, and a longitudinal axis. The optical fiber receives the light emitted by the light source at the proximal tip and emits characterization light from the distal tip. The system also includes a multi-stage axis that supports the optical fiber and translate the optical fiber is a first direction and/or a second direction. The system also includes a first camera facing toward the optical fiber that measures a first position of the distal tip and a first angle corresponding to the longitudinal axis. The system also includes a second camera facing toward the optical fiber that measures a second position of the distal tip and a second angle corresponding to the longitudinal axis. The system includes a position sensing device operable to measure the characterization light emitted from the distal tip.

The system may include various optional embodiments. The first camera may be disposed in a direction along that is orthogonal to the longitudinal axis. The second camera may be disposed in a direction that is orthogonal to the longitudinal axis. The first camera and the second camera may be disposed in directions that are orthogonal to the longitudinal axis and the first camera is disposed in a direction that is orthogonal to the second camera. The system may include a first backlight disposed opposite the first camera and operable to illuminate at least the distal tip of the optical fiber. The system may include a second backlight disposed opposite the second camera and operable to illuminate at least the distal tip of the optical fiber. The system may further include an optical fiber chuck configured to support the optical fiber. The optical fiber chuck may include a mechanical clamp or a vacuum clamp.

According to another embodiment of the present disclosure, a method for measuring a cleave angle of an optical fiber includes providing an optical fiber having a longitudinal axis and a distal tip characterized by a cleave angle, imaging the distal tip of the optical fiber, and translating the optical fiber via a multi-stage axis to reduce or minimize a distance from the distal tip of the optical fiber and the longitudinal axis. The method also includes determining, based on the imaging, a pose of the distal tip of the optical fiber and emitting light from a light source. The optical fiber receives the light emitted by the light source. The method also includes emitting characterization light from the distal tip of the optical fiber, detecting, at an image sensor, the characterization light, and determining, based on the characterization light and the pose of the distal tip of the optical fiber, the cleave angle of the optical fiber.

The method may include various optional embodiments. An optical fiber chuck may support the optical fiber. The pose of the distal tip of the optical fiber may include a position and angle. The imaging may be performed by a first camera and a second camera. The first camera and the second camera may be disposed in directions that are orthogonal to the longitudinal axis. The first camera may measure a first position of the distal tip and a first angle corresponding to the longitudinal axis. The second camera may measure a second position of the distal tip and a second angle corresponding to the longitudinal axis. The first camera may be disposed in a direction that is orthogonal to the second camera. The image sensor may be a camera or a quadrant photodiode. The method may include detecting, at the image sensor, the characterization light and determining a position of the characterization light. The method may include illuminating the distal tip via a first backlight disposed opposite the first camera and a second backlight disposed opposite the second camera.

Numerous benefits are achieved by way of the present disclosure over conventional techniques. For example, embodiments of the present invention enable high accuracy cleave angle measurement that may be easily adapted for automation. For example, in an automation setting, at least some embodiments of the cleave angle measurement systems described herein may be integrated with other inspections. Specifically, data associated with quality and cleanliness of the stripping process may be collected during the cleave angle measurement processes described herein. A further advantage of at least some embodiments of the system described herein is that the optical fiber may be clamped onto buffer material or glass, thereby preventing potential damage to the glass without requiring excessive strip lengths. Various embodiments of the present disclosure use machine vision to compensate for systematic errors that are often introduced from fiber holding mechanisms. At least some embodiments use motion control coupled with machine vision to reduce or minimize measurement errors. These and other embodiments of the disclosure, along with many of its advantages and features, are described in more detail in conjunction with the text below and corresponding figures.

### BRIEF DESCRIPTION OF THE DRAWINGS

FIG. 1 illustrates a side view of an optical fiber having a cleave angle.

FIG. 2 is a simplified schematic diagram of a cleave angle measurement system, according to an embodiment of the present invention.

FIG. 3 is a simplified perspective view of a cleave angle measurement system, according to an embodiment of the present invention.

FIG. 4 is a simplified flowchart illustrating a method for measuring a cleave angle of an optical fiber using a cleave angle measurement system according to an embodiment of the present invention.

FIG. 5 is a simplified perspective view of a cleave angle measurement system, according to another embodiment of the present invention.

FIG. 6 is a simplified flowchart illustrating a method for measuring a cleave angle of an optical fiber using an a cleave angle measurement system according to another embodiment of the present invention.

### DETAILED DESCRIPTION OF THE INVENTION

The present disclosure relates generally to methods and systems related to optical systems including optical fibers. More particularly, embodiments of the present invention provide methods and systems that can be used for determining a cleave angle of an optical fiber. The disclosure is applicable to a variety of applications in lasers and optics, including fiber laser implementations.

During an alignment process, an optical fiber may be aligned with an external body. For example, optical fibers are often spliced to various external bodies, such as another optical fiber or a piece of optical equipment, and precise alignment between the optical fiber and the external body is utilized to maximized power transmission to or from the external body.

Manufacturing properties of the optical fiber, however, may impact the alignment process. For example, an optical fiber may include a cleaved end. The cleaved end of an optical fiber may be an end of the optical fiber having a cleave or cut that is perpendicular to the longitudinal length of the optical fiber. The cleave is generally made during a manufacturing process of the optical fiber. The angle of the cleaved end, referred to herein as a cleave angle, may impact the alignment process. The cleave angle is a reference to how perpendicular the cleaved end of the optical fiber is to the optical axis of the fiber. Typically, the optical axis of the optical fiber is along the longitudinal length of the optical fiber, and thus the cleave angle may be the degree to which the cleaved end is perpendicular to the length of the optical fiber.

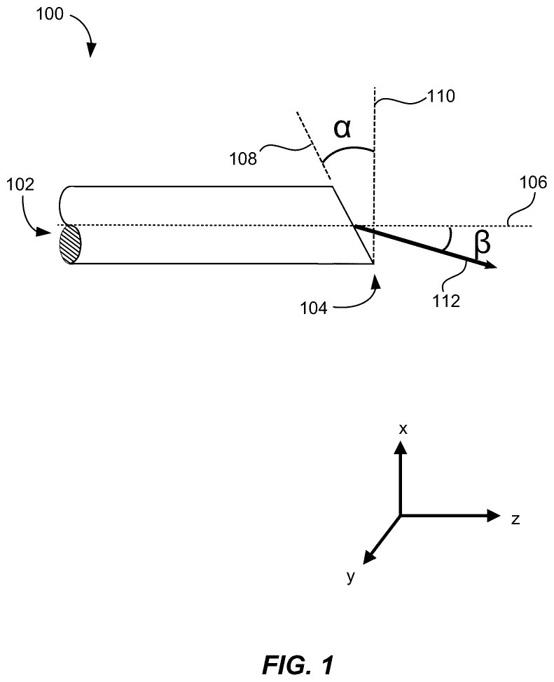

FIG. 1 illustrates a side view of an optical fiber having a cleave angle. An optical fiber 100 includes a proximal tip 102, a distal tip 104, and a longitudinal axis 106 (also referred to as the mechanical axis or a nominal optical axis of the optical fiber 100, in at least some embodiments). A cleave angle α is measured from a first axis 108 defined by the cleaved, distal tip 104 to a second axis 110 that is perpendicular to the longitudinal axis 106.

A light source (not shown) configured to emit light may be provided in conjunction with the optical fiber 100. The optical fiber 100 may be configured to receive the light emitted by the light source at the proximal tip 102. Light emitted from the light source and received by the optical fiber 100 passes through the optical fiber 100. The optical fiber 100 is further configured to emit the light received from the light source as characterization light from the distal tip 104. The characterization light may be referred to an optical output ray 112, according to various embodiments of the present disclosure. The optical output ray 112 may propagate along a direction that is oriented at an angle β with respect to the longitudinal axis 106. As will be understood by one having ordinary skill in the art, generally, as the cleave angle α increases, a corresponding angle β defined by the optical output ray 112 increases. Accordingly, a larger cleave angle α results in larger deflection of the optical output ray 112 away from the longitudinal axis 106 of the optical fiber 100.

The cleave angle of an optical fiber may impact the alignment process for the optical fiber. Specifically, the cleave angle of the optical fiber may impact the angle and orientation (e.g., offset) at which light is emitted from the cleaved end of the optical fiber. Conventional approaches, however, to measuring the cleave angle of an optical fiber are often unable to measure the cleave angle to within a degree of an angle and often have minimal repeatability. Moreover, conventional methods may be fiber-type specific, requiring mode matching and wavelength matching between the optical fiber and the measuring equipment. As such, there is a need in the art for improved methods and systems related to measuring a cleave angle of an optical fiber. Conventional methodologies are effectively limited to measuring cleave angles greater than 0.5 degrees.

In various applications, a cleaved end of an optical fiber, such as optical fiber 100, is preferably at a 90 degree angle relative to the longitudinal length of the optical fiber. In other words, after cleaving the optical fiber, the distal tip 104 of the optical fiber 100 is perpendicular to the longitudinal length of the fiber (e.g., longitudinal axis 106 of the optical fiber 100). In this case, the cleave angle α is equal to zero degrees. For example, a 90 degree angle between the cleaved end of the optical fiber and the longitudinal length of the optical fiber can be an ideal angle at which to fuse two fibers together. In other applications, a predetermined cleave angle not equal to zero degrees can be desired, for example, in some specialized applications. In any application, it is generally desirable to have a repeatable and accurate way to measure the cleave angle α of the optical fiber, whether it is zero degrees or a non-zero angle.

To provide accurate and consistent measurements of a cleave angle α of an optical fiber to below and including a cleave angle α of 0.5 degree, a cleave angle measurement system that measures the optical output of the optical fiber is provided herein.

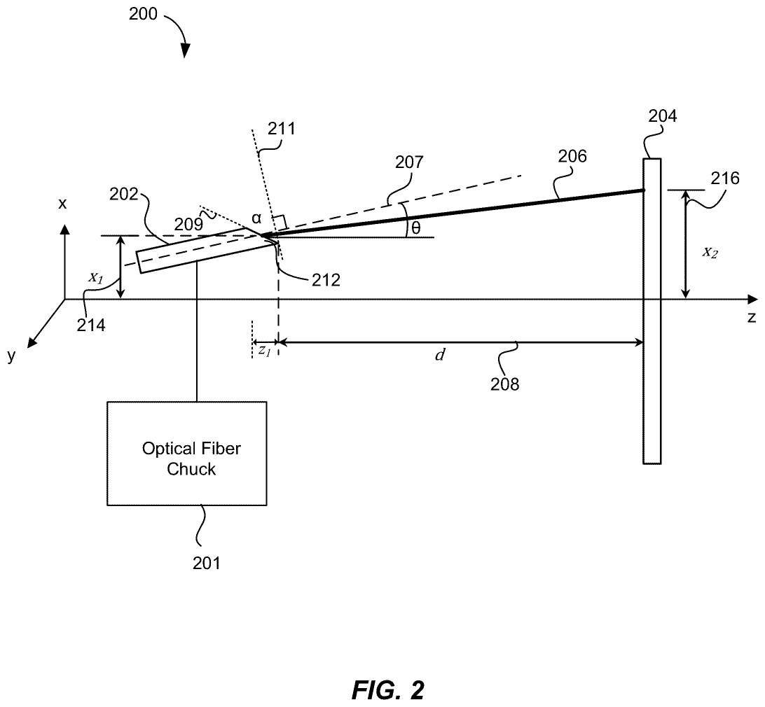

FIG. 2 is a simplified schematic diagram of a cleave angle measurement system, according to an embodiment of the present invention. A cleave angle measurement system 200 includes an optical fiber chuck 201 that is configured to support an optical fiber 202 and an image sensor 204 that is configured to detect characterization light 206 emitted from the optical fiber 202. Various distances with respect to the optical fiber 202 are measured as part of the cleave angle measure system 200. Distance d 208 refers to a distance measured along the z-axis between the distal tip 212 of the optical fiber 202 and the image sensor 204.

A first distance x₁ 214 refers to a distance measured along the x-axis between the distal tip 212 of the optical fiber 202 and the z-axis. A second distance x₂ 216 refers to a distance along the x-axis between a point where the characterization light 206 meets the image sensor 204 and the z-axis. Angle θ is the angle between the direction of propagation of the characterization light 206 and the z-axis. First distance x₁ 214 and angle θ may be measured by one or more cameras, not shown. The second distance x₂ 216 may be measured by the image sensor 204. As shown, the optical fiber 202 is displaced from (e.g., tilted with respect to) the z-axis. In various embodiments, the optical fiber 202 is substantially aligned with the z-axis such that a longitudinal axis 207 of the optical fiber 202 is parallel to the z-axis. A cleave angle α is measured from a first axis 209 defined by the cleaved, distal tip 104 to a second axis 211 that is perpendicular to the longitudinal axis 207.

According to various embodiments of the present disclosure, indices of refraction may be assumed (e.g., known) and the position(s) of the camera(s) are predefined. For example, the index of refraction corresponding to the optical fiber 202 that is used for one or more computations described throughout the present disclosure can be the effective index of the optical fiber cladding, n₁ and/or the index of refraction of the core of the optical fiber 202 (i.e., the core index), n₂. Furthermore, a distance d 208 referring to a distance measured along the z-axis between the distal tip of the optical fiber and the image sensor 204 (e.g., position sensing device) is known.

In some embodiments, a second distance x₂ 216 may be calculated as follows:

$${x}_{2} = {x}_{1} + d ( θ + ( \frac{{n}_{2}}{{n}_{1}} - 1 ) α )$$

Accordingly, the cleave angle α may be calculated as follows:

$$α = \frac{{x}_{2} - {x}_{1} - θ d}{( \frac{{n}_{2}}{{n}_{1}} - 1 ) d}$$

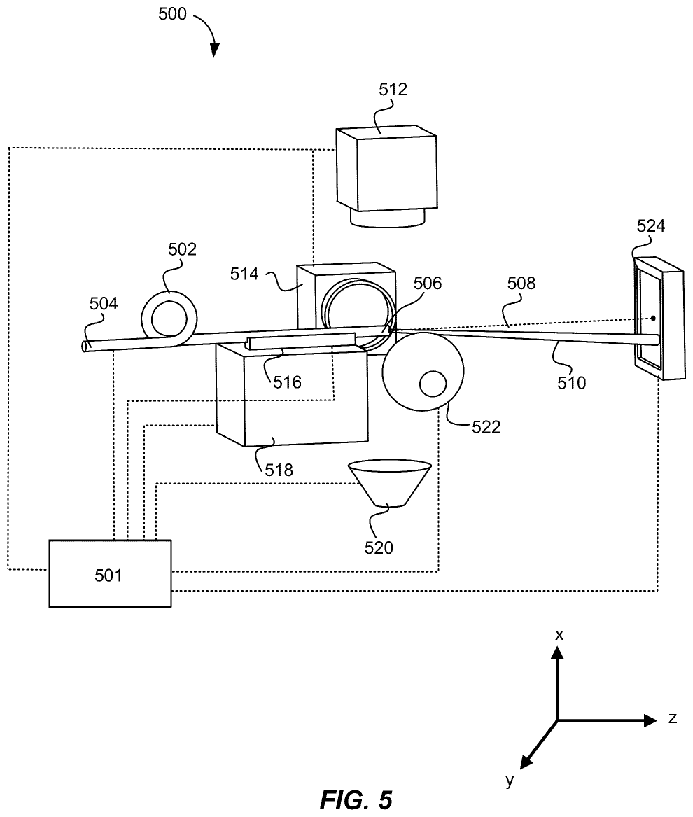

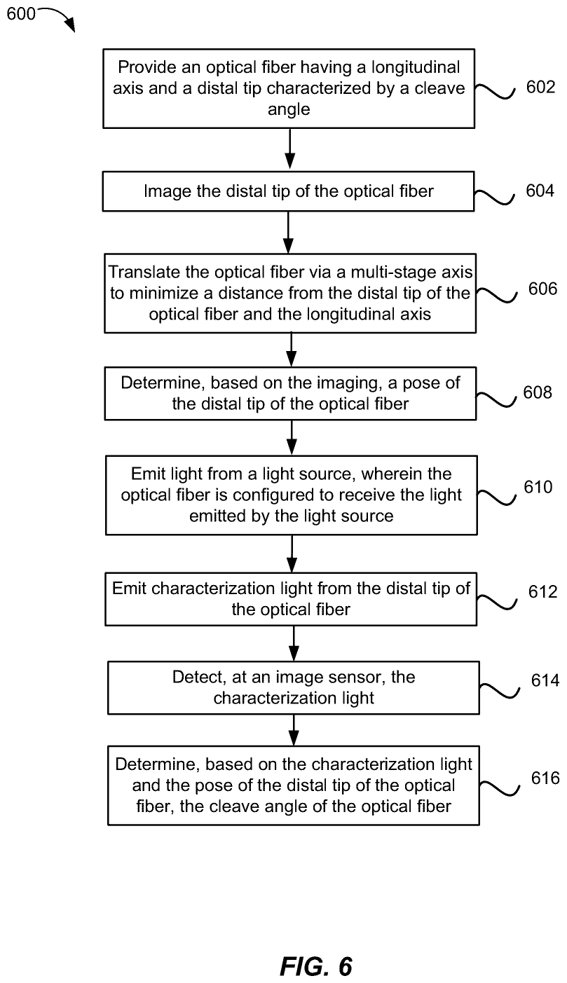

Static and active methods of cleave angle measurements using the systems described herein include embodiments described in detail below. A static method does not include a multi-axis stage (such as multi-axis stage 518 described with respect to FIG. 5 and FIG. 6). The static method provides a lower cost solution and reduces system complexity by eliminating components that will require maintenance or be sources of failure. The active method, including a multi-axis stage (such as multi-axis stage 518 described with respect to FIG. 5 and FIG. 6), may yield improved accuracy. For example, higher magnification cameras will have reduced depth of focus. An optical fiber located slightly out of the plane may provide an additional source of error since the position is less well known. Having a multi-axis stage and moving the optical fiber into a well-behaved region improves accuracy of optical measurements.

According to at least some embodiments, the position of one or more cameras are predefined, the position sensing device origin is predefined, a nominal distance d referring to a distance along the z-axis between the distal tip of the optical fiber and the image sensor (e.g., position sensing device) is known, and the indices of refraction (n₁ and n₂) are known. An optical fiber is placed into an optical fiber chuck and the distal tip of the optical fiber is imaged. An offset of the optical fiber distal tip may be calculated (e.g., if the optical fiber is tilted, an angle θ as described above may be calculated). A first distance x₁ referring to a distance along the x-axis between the distal tip of the optical fiber and the z-axis at a predetermined x-position is determined from the imaging. Similarly, a distance z₁ referring to a distance along the z-axis accounting for error in nominal distance d is determined from the imaging.

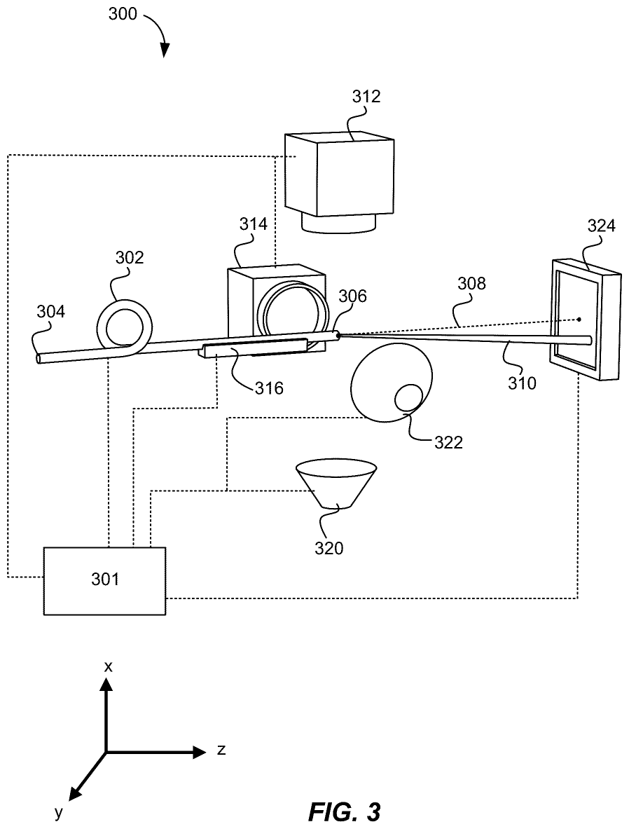

FIG. 3 is a simplified perspective view of a cleave angle measurement system, according to an embodiment of the present invention. The cleave angle measurement system 300 may be used to perform at least some embodiments of the static method described herein. The cleave angle measurement system 300 includes an optical fiber chuck 316 configured to receive an optical fiber 302 having a proximal tip 304, a distal tip 306, and a nominal optical axis 308. A light source (not shown) may be provided proximal to the proximal tip 304 of the optical fiber 302 and the light source may be configured to emit light. For example, the light source may be a laser coupled into the optical fiber 302 at the proximal tip 304 such that light emitted from the light source passes through the optical fiber 302 toward the distal tip 306. Thus, the optical fiber 302 is configured to receive light emitted by the light source at the proximal tip 304 of the optical fiber 302 and emit characterization light 310 from the distal tip 306 of the optical fiber 302.

In various embodiments, the cleave angle measurement system 300 includes one or more cameras that are focused on and measure the position and orientation (i.e., the pose) of the distal tip 306 of the optical fiber 302. The cleave angle measurement system 300 includes a pair of cameras for detecting and/or measuring the pose of the distal tip 306 of the optical fiber 302. The pose of the distal tip 306 of the optical fiber 302 as referred to throughout the present disclosure includes the six degrees of freedom (DOF) pose of the optical fiber 302, specifically, the distal tip 306 of the optical fiber 302. In particular, the pose of the optical fiber 302 refers to the six mechanical degrees of freedom of movement of a rigid body (e.g., the optical fiber 302) in three-dimensional space including forward/backward (surge), up/down (heave), left/right (sway) translation in three perpendicular axes, combined with changes in orientation through rotation about three perpendicular axes, often termed yaw (normal axis), pitch (transverse axis), and roll (longitudinal axis). For example, the pose of the distal tip 306 of the optical fiber 302 includes a position and angle in the direction of each of the x-axis and the y-axis. According to any of the embodiments described herein, a position may be detected, measured, determined, reported, etc., as a coordinate pair (e.g., (x, y)) or as a coordinate trio (e.g., (x, y, z)), as would be appreciated by a person having ordinary skill in the art upon reading the present disclosure.

As shown, the cleave angle measurement system 300 includes a first camera 312 facing toward the optical fiber 302. In some embodiments, the first camera 312 is positioned at a higher x-position along the x-axis than the x-position of the optical fiber 302 such that the first camera 312 is positioned above and aligned with the optical fiber 302. Furthermore, the first camera 312 may be positioned facing downward and toward the optical fiber 302. The first camera 312 is configured to measure a first position of the distal tip 306 of the optical fiber 302 and a first angle corresponding to the nominal optical axis 308 (e.g., the longitudinal axis) of the optical fiber 302. In this particular configuration, the nominal optical axis 308 of the optical fiber 302 is aligned with the z-axis and the nominal optical axis 308 may be interchangeably referred to as the longitudinal axis. In other configurations, the nominal optical axis 308 of the optical fiber 302 is tilted relative to the z-axis and an angle θ is measured between the nominal optical axis 308 of the optical fiber 302 and the z-axis, such as the angle θ described with respect to FIG. 2. In various embodiments, the first camera 312 is disposed in a plane orthogonal to the nominal optical axis 308 of the optical fiber 302 (in this configuration, the longitudinal axis, or the z-axis).

The cleave angle measurement system 300 further includes a second camera 314 facing toward the optical fiber 302. In some embodiments, the second camera 314 is positioned at an x-position equal to or close to the x-position of the optical fiber 302 such that the second camera 314 is aligned with the distal tip 306 of the optical fiber 302. The second camera 314 is configured to measure a second position of the distal tip 306 of the optical fiber 302 and a second angle corresponding to the nominal optical axis 308 of the optical fiber 302. The second camera 314 is disposed in the plane orthogonal to the nominal optical axis 308 of the optical fiber 302 (in this configuration, the longitudinal axis, or the z-axis). For example, in at least some embodiments, the first camera 312 and the second camera 314 are disposed along directions that are orthogonal to the longitudinal axis and the first camera 312 is disposed along a direction that is orthogonal to the direction along which the second camera 314 is disposed.

In various embodiments, each of the first camera 312 and the second camera 314 detect (e.g., measure) the pose of the distal tip 306 of the optical fiber 302 and report the measurements associated with the pose to be used for cleave angle computation, to be described in detail below.

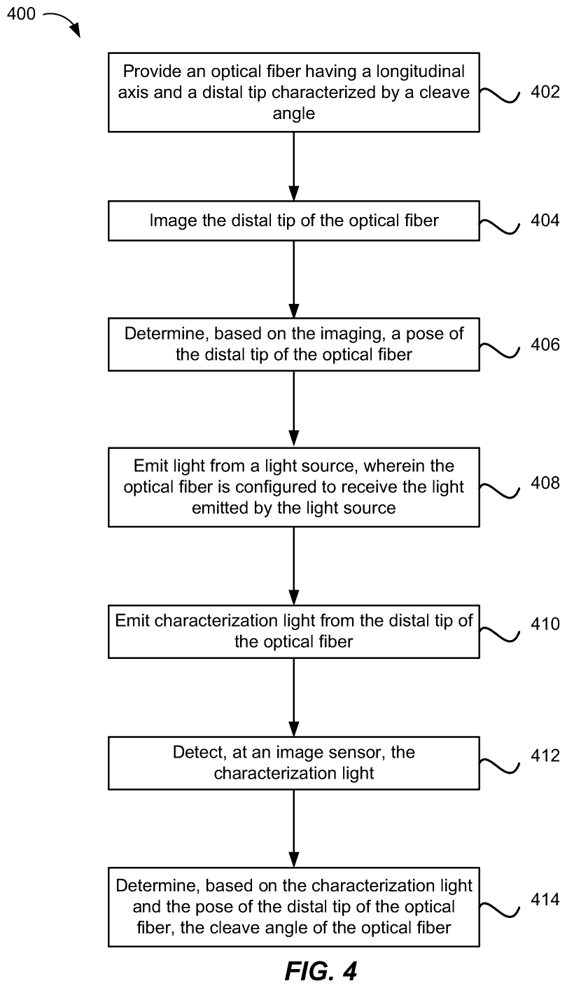

In various embodiments, cleave angle measurement system 300 includes one or more processors 301 to perform the various aspects of the methods described herein. The one or more processors 301 cause various components of cleave angle measurement system 300 to perform one or more functions. For example, the one or more processors 301 are adapted to cause the first camera 312 and the second camera 314 to image the distal tip 306 of the optical fiber 302. Furthermore, the one or more processors 301 perform various operations including determining, based on the imaging, a pose of the distal tip 306 of the optical fiber 302 and determining, based on the characterization light 310 and the pose of the distal tip 306 of the optical fiber 302, the cleave angle of the optical fiber 302, to be described in further detail below with respect to FIG. 4 and method 400.

The cleave angle measurement system 300 may include an optical fiber chuck 316 configured to support the optical fiber 302. In some embodiments, the optical fiber chuck 316 may include a mechanical clamp, a vacuum clamp, or any other clamping mechanism known in the art. In some embodiments, the optical fiber chuck 316 is configured to align the nominal optical axis 308 of the optical fiber 302 with the longitudinal axis (e.g., the z-axis) such as in the configuration shown in FIG. 3. In some embodiments, the optical fiber chuck 316 is configured to translate along the z-axis and thus translates the optical fiber 302 along the z-axis as it is supported by the optical fiber chuck 316. For example, the optical fiber chuck 316 and/or the optical fiber 302 may be displaced along the z-axis so that the optical fiber chuck 316 and/or the optical fiber 302 can be positioned at different z-positions along the z-axis.

The cleave angle measurement system 300 may further include one or more backlights to illuminate the distal tip 306 of the optical fiber 302. In other embodiments, reflective illumination may be used to illuminate the distal tip 306 of the optical fiber 302. In the embodiment illustrated in FIG. 3, the cleave angle measurement system 300 includes a first backlight 320 disposed opposite the first camera 312. The first backlight 320 is operable to illuminate at least the distal tip 306 of the optical fiber 302. The cleave angle measurement system 300 may also include a second backlight 322 disposed opposite the second camera 314. The second backlight 322 is operable to illuminate at least the distal tip 306 of the optical fiber 302. In various embodiments, the first backlight 320 is disposed in a plane orthogonal to a plane in which the second backlight 322 is disposed. In further embodiments, the first camera 312, the first backlight 320, the second backlight 322, and the second camera 314 may each be disposed in a direction that is orthogonal to each other and the first camera 312, the first backlight 320, the second backlight 322, and the second camera 314 may each be located in a direction that is orthogonal to the z-axis (e.g., the longitudinal axis, in this case, the nominal optical axis 308 of the optical fiber 302). In other embodiments, other configurations of the first camera 312, the first backlight 320, the second backlight 322, and the second camera 314 may be used as would be understood by one having ordinary skill in the art upon reading the present disclosure.

The cleave angle measurement system 300 further includes a position sensing device 324 that is operable to measure the characterization light 310 emitted from the distal tip 306 of the optical fiber 302. The position sensing device 324 may be a camera, a quadrant photodiode, an image sensor, etc. The characterization light 310 emitted from the distal tip 306 of the optical fiber 302 is emitted onto the receiving surface of the position sensing device 324. The detected (e.g., measured) position of the characterization light 310 on the position sensing device 324 is reported and used for cleave angle computation, to be described in detail below.

FIG. 4 is a simplified flowchart illustrating a method for measuring a cleave angle of an optical fiber using a cleave angle measurement system according to an embodiment of the present invention. The method 400 includes providing an optical fiber having a longitudinal axis and a distal tip characterized by a cleave angle (402). The cleaved end of an optical fiber may be an end of the optical fiber having a cleave or cut that is perpendicular to the longitudinal length of the optical fiber. The cleave angle is a reference to how perpendicular the cleaved end of the optical fiber is to the optical axis of the fiber. Typically, the optical axis of the optical fiber is along the longitudinal length of the optical fiber, and thus the cleave angle may be the degree to which the cleaved end is perpendicular to the length of the optical fiber, as described in detail above.

The method also includes imaging the distal tip of the optical fiber (404). In various embodiments, imaging is performed by a first camera and a second camera. For example, the first camera can face toward the optical fiber and may be positioned at a higher x-position on an x-axis including the optical fiber such that the first camera is above and aligned with the optical fiber. Furthermore, the first camera may be positioned facing downward and toward the optical fiber to image the distal tip of the optical fiber. A second camera can face toward the optical fiber. In some embodiments, the second camera is positioned at or near the x-position of the optical fiber on an x-axis including the optical fiber such that the second camera is aligned with the distal tip of the optical fiber. The first camera and the second camera may each be disposed in a direction that is orthogonal to the longitudinal axis. In at least some embodiments, the first camera may be disposed in a direction that is orthogonal to a direction that the second camera is disposed.

The method further includes determining, based on the imaging, a pose of the distal tip of the optical fiber (406). The pose of the distal tip of the optical fiber includes at least a position and angle of the distal tip. For example, the first camera detects (e.g., measures) a first position of the distal tip and a first angle corresponding to the longitudinal axis and the second camera detects (e.g., measures) a second position of the distal tip and a second angle corresponding to the longitudinal axis. In various embodiments, the pose of the distal tip of the optical fiber includes measurements associated with each of the six degrees of freedom of the optical fiber.

According to at least some embodiments of the static method, the position of one or more cameras are predefined, the position sensing device origin is predefined, a distance d referring to a distance along the z-axis between the distal tip of the optical fiber and the image sensor (e.g., position sensing device) is known, and the indices of refraction (n₁ and n₂) are known. An optical fiber is placed into an optical fiber chuck and the distal tip of the optical fiber is imaged. An offset of the optical fiber distal tip may be calculated (e.g., if the optical fiber is tilted, an angle θ as described above may be calculated). A first distance x₁ referring to a distance along the x-axis between the distal tip of the optical fiber and the z-axis at a predetermined x-position is determined from the imaging. A distance z₁ referring to a distance along the z-axis accounting for error in nominal distance d is determined from the imaging.

In at least some embodiments, determining the pose of the distal tip of the optical fiber includes translating the optical fiber chuck and the optical fiber along the longitudinal axis. Translating the optical fiber chuck and the optical fiber along the longitudinal axis includes displacing the optical fiber along the longitudinal axis. In some embodiments, a multi-axis stage may be used to translate the optical fiber chuck and the optical fiber along the longitudinal axis (e.g., the z-axis) and along the x-axis.

The method further includes emitting light from a light source (408). A light source may be provided proximal to the proximal tip of the optical fiber and the light source may be configured to emit light. For example, the light source may be a laser coupled into the optical fiber from the proximal tip such that light emitted from the light source passes through the optical fiber toward the distal tip. The optical fiber is configured to receive the light emitted by the light source. The light passes through the longitudinal length of the optical fiber. The method further includes emitting characterization light from the distal tip of the optical fiber (410).

In various embodiments, method 400 may optionally include illuminating the distal tip via a first backlight disposed opposite the first camera and a second backlight disposed opposite the second camera. Reflection illumination methods may be used, according to at least some embodiments.

The method also includes detecting, at an image sensor, the characterization light (412). The image sensor may be a camera or a quadrant photodiode, according to various embodiments. Detecting, at the image sensor, the characterization light includes determining a position of the characterization light. The characterization light emitted from the distal tip of the optical fiber is emitted onto the receiving surface of the image sensor. The detected (e.g., measured) position of the characterization light on the image sensor may be reported with measurements from the first camera and the second camera.

The method further includes determining, based on the characterization light and the pose of the distal tip of optical fiber, the cleave angle of the optical fiber (414). According to various embodiments of the present disclosure, indices of refraction may be assumed (e.g., known) and the position(s) of the camera(s) are predefined. For example, the index of refraction including the effective index and/or the core index may be assumed for one or more computations described throughout the present disclosure. Furthermore, a distance d referring to a distance along the z-axis between the distal tip of the optical fiber and the image sensor (e.g., position sensing device) is known.

Light may be passed through the optical fiber and measured by the position sensing device with respect to the position of the first camera and the second camera. The cleave angle with respect to the x-direction αₓ may be calculated based on the following equation:

$${α}_{x} = \frac{{x}_{2} - {x}_{1} - ( d + {z}_{1} ) θ}{( \frac{{n}_{2}}{{n}_{1}} - 1 ) ( d + {z}_{1} )} .$$

The foregoing steps are repeated to solve for the cleave angle with respect to the y-direction ay based on the following equation:

$${α}_{y} = \frac{{y}_{2} - {y}_{1} - ( d + {z}_{1} ) θ}{( \frac{{n}_{2}}{{n}_{1}} - 1 ) ( d + {z}_{1} )} .$$

The cleave angle α is determined by the following equation: α=\sqrt{αₓ²+α_{y}²}.

It should be appreciated that the specific steps illustrated in FIG. 4 provide a particular method of measuring a cleave angle of an optical fiber using a cleave angle measurement system according to an embodiment of the present invention. Other sequences of steps may also be performed according to alternative embodiments. For example, alternative embodiments of the present invention may perform the steps outlined above in a different order. Moreover, the individual steps illustrated in FIG. 4 may include multiple sub-steps that may be performed in various sequences as appropriate to the individual step. Furthermore, additional steps may be added or removed depending on the particular applications. One of ordinary skill in the art would recognize many variations, modifications, and alternatives.

FIG. 5 is a simplified perspective view of a cleave angle measurement system, according to another embodiment of the present invention. FIG. 5 includes similar components as those shown and described with respect to FIG. 3. Accordingly, similar numbering may be used to describe components having similar configurations and/or functions and the description provided in relation to FIG. 3 is applicable to the elements illustrated in FIG. 5 as appropriate.

The cleave angle measurement system 500 includes an optical fiber chuck 516 configured to receive an optical fiber 502 having a proximal tip 504, a distal tip 506, and a nominal optical axis 508. A light source (not shown) may be provided proximal to the proximal tip 504 of the optical fiber and the light source may be configured to emit light. For example, the light source may be a laser coupled into the optical fiber 502 from the proximal tip 504 such that light emitted from the light source passes through the optical fiber 502 toward the distal tip 506. The optical fiber 502 is configured to receive light emitted by the light source at the proximal tip 504 of the optical fiber 502 and emit characterization light 510 from the distal tip 506 of the optical fiber 502.

In various embodiments, the cleave angle measurement system 500 includes one or more cameras that are focused onto the pose of the distal tip 506 of the optical fiber 502. The cleave angle measurement system 500 includes a pair of cameras for detecting and/or measuring the pose of the distal tip 506 of the optical fiber 502. The pose of the distal tip 506 of the optical fiber 502 as referred to throughout the present disclosure includes six degrees of freedom (DOF) of the optical fiber 502. In particular, the pose of the optical fiber 502 refers to the six mechanical degrees of freedom of movement of a rigid body (e.g., the optical fiber 502) in three-dimensional space including forward/backward (surge), up/down (heave), left/right (sway) translation in three perpendicular axes, combined with changes in orientation through rotation about three perpendicular axes, often termed yaw (normal axis), pitch (transverse axis), and roll (longitudinal axis). For example, the pose of the optical fiber 502 includes a position and angle in the direction of each of the x-axis and the z-axis.

As shown, the cleave angle measurement system 500 includes a first camera 512 facing toward the optical fiber 502. In some embodiments, the first camera 512 is positioned at a higher x-position on an x-axis including the optical fiber 502 such that the first camera 512 is above and aligned with the optical fiber 502. Furthermore, the first camera 512 may be positioned facing downward and toward the optical fiber 502. The first camera 512 is configured to measure a first position of the distal tip 506 of the optical fiber 502 and a first angle corresponding to the nominal optical axis 508 (e.g., the longitudinal axis) of the optical fiber 502. In this particular configuration, the nominal optical axis 508 of the optical fiber 502 is aligned with the z-axis and the nominal optical axis 508 may be interchangeably referred to as the longitudinal axis. In other configurations the nominal optical axis 508 of the optical fiber 502 is tilted relative to the z-axis and an angle θ is measured between the nominal optical axis 508 of the optical fiber 502 and the z-axis, such as the angle θ described with respect to FIG. 2. In various embodiments, the first camera 512 is disposed in a plane orthogonal to the nominal optical axis 508 of the optical fiber 502 (in this configuration, the longitudinal axis, or the z-axis).

The cleave angle measurement system 500 further includes a second camera 514 facing toward the optical fiber 502. In some embodiments, the second camera 514 is positioned at or near the x-position of the optical fiber 502 an on x-axis including the optical fiber 502 such that the second camera 514 is aligned with the optical fiber 502. The second camera 514 is configured to measure a second position of the distal tip 506 of the optical fiber 502 and a second angle corresponding to the nominal optical axis 508 of the optical fiber 502. The second camera 514 is disposed in the plane orthogonal to the nominal optical axis 508 of the optical fiber 502 (in this configuration, the longitudinal axis, or the z-axis). For example, in at least some embodiments, the first camera 512 and the second camera 514 are disposed along directions that are orthogonal to the longitudinal axis and the first camera 512 is disposed along a direction that is orthogonal to the direction along which the second camera 514 is disposed.

In various embodiments, each of the first camera 512 and the second camera 514 detect (e.g., measure) the pose of the distal tip 506 of the optical fiber 502 and report the measurements associated with the pose to be used for cleave angle computation, to be described in detail below.

The cleave angle measurement system 500 may include an optical fiber chuck 516 configured to support the optical fiber 502. In some embodiments, the optical fiber chuck 516 may include a mechanical clamp, a vacuum clamp, or any other clamping mechanism known in the art. In some embodiments, the optical fiber chuck 516 is configured to align the nominal optical axis 508 of the optical fiber 502 with the longitudinal axis (e.g., the z-axis) such as in the configuration shown in FIG. 5. In some embodiments, the optical fiber chuck 516 is configured to translate along the z-axis and further translate the optical fiber 502 the optical fiber chuck 516 supports along the z-axis. For example, the optical fiber chuck 516 and/or the optical fiber 502 may be displaced to different z-positions along the z-axis.

In various embodiments, FIG. 5 illustrates an “active” method of cleave angle measurement. For example, cleave angle measurement system 500 includes a multi-axis stage 518. The multi-axis stage 518 is coupled to the optical fiber chuck 516 and/or the optical fiber 502 such that the optical fiber chuck 516 and/or the optical fiber 502 may be translated in both a direction oriented along the x-axis and a direction oriented along the z-axis. Accordingly, incremental changes in pose of the distal tip 306 of the optical fiber 302 (e.g., at least the position and angle in the x-direction and the y-direction) may be detected (e.g., measured) and reported by the first camera 512, the second camera 514, and the position sensing device 524.

In various embodiments, cleave angle measurement system 500 includes one or more processors 501 to perform the various aspects of the methods described herein. The one or more processors 501 cause various components of cleave angle measurement system 500 to perform one or more functions. For example, the one or more processors 501 are adapted to cause the first camera 512 and the second camera 514 to image the distal tip 506 of the optical fiber 502. Furthermore, the one or more processors 501 perform various operations including determining, based on the imaging, a pose of the distal tip 506 of the optical fiber 502 and determining, based on the characterization light 510 and the pose of the distal tip 506 of the optical fiber 502, the cleave angle of the optical fiber 502, to be described in further detail below with respect to FIG. 6 and method 600.

The cleave angle measurement system 500 may further include one or more backlights to illuminate the distal tip 506 of the optical fiber 502. In some embodiments, reflective illumination may be used to illuminate the distal tip 506 of the optical fiber 502. In some embodiments, the cleave angle measurement system 500 includes a first backlight 520 disposed opposite the first camera 512. The first backlight 520 is operable to illuminate at least the distal tip 506 of the optical fiber 502. The cleave angle measurement system 500 may also include a second backlight 522 disposed opposite the second camera 514. The second backlight 522 is operable to illuminate at least the distal tip 506 of the optical fiber 502. In various embodiments, the first backlight 520 is disposed orthogonal to the second backlight 522. In further embodiments, the first camera 512, the first backlight 520, the second backlight 522, and the second camera 514 are orthogonal to each other and located in a plane orthogonal to the z-axis (e.g., the longitudinal axis, in this case, the nominal optical axis 508 of the optical fiber 502). In other embodiments, other configurations of the first camera 512, the first backlight 520, the second backlight 522, and the second camera 514 may be used as would be understood by one having ordinary skill in the art upon reading the present disclosure.

The cleave angle measurement system 500 further includes a position sensing device 524 that is operable to measure the characterization light 510 emitted from the distal tip 506 of the optical fiber 502. The position sensing device 524 may be a camera, a quadrant photodiode, an image sensor, etc. The characterization light 510 emitted from the distal tip 506 of the optical fiber 502 is emitted onto the receiving surface of the position sensing device 524. The detected (e.g., measured) position of the characterization light 510 on the position sensing device 524 is reported and used for cleave angle computation, to be described in detail below.

FIG. 6 is a simplified flowchart illustrating a method for measuring a cleave angle of an optical fiber using a cleave angle measurement system according to another embodiment of the present invention. The method 600 includes providing an optical fiber having a longitudinal axis and a distal tip characterized by a cleave angle (602). The cleaved end of an optical fiber may be an end of the optical fiber having a cleave or cut that is perpendicular to the longitudinal length of the optical fiber. The cleave angle is a reference to how perpendicular the cleaved end of the optical fiber is to the optical axis of the fiber. Typically, the optical axis of the optical fiber is along the longitudinal length of the optical fiber, and thus the cleave angle may be the degree to which the cleaved end is perpendicular to the length of the optical fiber, as described in detail above.

The method also includes imaging the distal tip of the optical fiber (604). In various embodiments, imaging is performed by a first camera and a second camera. For example, the first camera can face toward the optical fiber and may be positioned at a higher x-position on an x-axis including the optical fiber such that the first camera is above and aligned with the optical fiber. Furthermore, the first camera may be positioned facing downward and toward the optical fiber to image the distal tip of the optical fiber. A second camera can face toward the optical fiber. In some embodiments, the second camera is positioned at or near the x-position of the optical fiber on an x-axis including the optical fiber such that the second camera is aligned with the distal tip of the optical fiber. The first camera and the second camera may each be disposed in a direction that is orthogonal to the longitudinal axis. In at least some embodiments, the first camera may be disposed is a direction that is orthogonal to a direction that the second camera is disposed.

The method further includes translating the optical fiber via a multi-stage axis to reduce or minimize a distance from the distal tip of the optical fiber and the longitudinal axis (606). According to the active method, the multi-axis stage may be translated in the x-direction until the first distance x₁ is reduced or minimized. For example, the multi-axis stage may be translated downwards such that the distal tip of the of the optical fiber is aligned with the longitudinal axis and/or the distal tip of the optical fiber is not tilted with respect to the longitudinal axis. In some embodiments, a multi-axis stage may be used to translate the optical fiber chuck and the optical fiber along the longitudinal axis (e.g., the z-axis) and along the x-axis.

The method further includes determining, based on the imaging, a pose of the distal tip of the optical fiber (608). The pose of the distal tip of the optical fiber includes at least a position and angle of the distal tip. For example, the first camera detects (e.g., measures) a first position of the distal tip and a first angle corresponding to the longitudinal axis and the second camera detects (e.g., measures) a second position of the distal tip and a second angle corresponding to the longitudinal axis. In various embodiments, the pose of the distal tip of the optical fiber includes measurements associated with each of the six degrees of freedom of the optical fiber.

According to at least some embodiments of the active method, the position of one or more cameras are predefined, the position sensing device origin is predefined, a distance d referring to a distance along the z-axis between the distal tip of the optical fiber and the image sensor (e.g., position sensing device) is known, and the indices of refraction (n₁ and n₂) are known. An optical fiber is placed into an optical fiber chuck and the distal tip of the optical fiber is imaged. An offset of the optical fiber distal tip may be calculated (e.g., if the optical fiber is tilted, an angle θ as described above may be calculated). A first distance x₁ referring to a distance along the x-axis between the distal tip of the optical fiber and the z-axis at a predetermined x-position is determined from the imaging.

The method further includes emitting light from a light source (610). A light source may be provided proximal to the proximal tip of the optical fiber and the light source may be configured to emit light. For example, the light source may be a laser coupled into the optical fiber from the proximal tip such that light emitted from the light source passes through the optical fiber toward the distal tip. The optical fiber is configured to receive the light emitted by the light source. The light passes through the longitudinal length of the optical fiber. The method further includes emitting characterization light from the distal tip of the optical fiber (612).

In various embodiments, method 600 may optionally include illuminating the distal tip via a first backlight disposed opposite the first camera and a second backlight disposed opposite the second camera. Reflection illumination methods may be used, according to at least some embodiments.

The method also includes detecting, at an image sensor, the characterization light (614). The image sensor may be a camera or a quadrant photodiode, according to various embodiments.

Detecting, at the image sensor, the characterization light includes determining a position of the characterization light. The characterization light emitted from the distal tip of the optical fiber is emitted onto the receiving surface of the image sensor. The detected (e.g., measured) position of the characterization light on the image sensor may be reported with measurements from the first camera and the second camera.

The method further includes determining, based on the characterization light and the pose of the distal tip of optical fiber, the cleave angle of the optical fiber (616). According to various embodiments of the present disclosure, indices of refraction may be assumed (e.g., known) and the position(s) of the camera(s) are predefined. For example, the index of refraction including the effective index and/or the core index may be assumed for one or more computations described throughout the present disclosure. Furthermore, a distance d referring to a distance along the z-axis between the distal tip of the optical fiber and the image sensor (e.g., position sensing device) is known.

Light may be passed through the optical fiber and measured by the position sensing device with respect to the position of the first camera and the second camera. According to some embodiments of the active method, the multi-axis stage may be translated in the x-direction and/or the z-direction until the first distance x₁ and the distance z₁ are minimized to zero and the cleave angle with respect to the x-direction or may be calculated based on the following equation:

$${α}_{x} = \frac{{x}_{2} - ( d ) θ}{( \frac{{n}_{2}}{{n}_{1}} - 1 ) ( d )} .$$

The foregoing steps are repeated to solve for the cleave angle with respect to the y-direction α_{y}:

$${α}_{y} = \frac{{y}_{2} - ( d ) θ}{( \frac{{n}_{2}}{{n}_{1}} - 1 ) ( d )} .$$

The cleave angle α is determined by the following equation: α=\sqrt{αₓ²+α_{y}²}.

According to some embodiments of the active method, the multi-axis stage may be translated in the x-direction and/or the z-direction and rotated around the y-axis until the first distance x₁, the distance z₁, and angle θ are minimized such that the equation to solve for the The cleave angle with respect to the y-direction α_{y} is

$${α}_{y} = \frac{{y}_{2}}{( \frac{{n}_{2}}{{n}_{1}} - 1 ) ( d )} .$$

The cleave angle α is determined by the following equation: α=\sqrt{αₓ²+α_{y}²}.

In another embodiment, a position and angle may be selected as a reference origin where the distal tip of the optical fiber will be centered and in focus. The optical fiber may be placed onto the optical fiber chuck and moved to the preset origin. Light may be passed through the optical fiber and the positions and angles are measured and recorded for each of the x-axis and the z-axis. The foregoing steps may be repeated as the optical fiber is rotated between measurements to create a circular locus of points on the sensor plane from multiple samplings. If the multi-axis stage is not used, each sampled point is transformed to accommodate the measured x₁ and θ offsets, in a manner that would become apparent to one having ordinary skill in the art upon reading the present disclosure. The centroid of the locus defines the nominal sensor centroid for the system and the centroid may be stored and used as the reference origin for future measurements.

It should be appreciated that the specific steps illustrated in FIG. 6 provide a particular method of measuring a cleave angle of an optical fiber using a cleave angle measurement system according to an embodiment of the present invention. Other sequences of steps may also be performed according to alternative embodiments. For example, alternative embodiments of the present invention may perform the steps outlined above in a different order. Moreover, the individual steps illustrated in FIG. 6 may include multiple sub-steps that may be performed in various sequences as appropriate to the individual step. Furthermore, additional steps may be added or removed depending on the particular applications. One of ordinary skill in the art would recognize many variations, modifications, and alternatives.

The technology described and claimed herein is not to be limited in scope by the specific preferred embodiments herein disclosed, since these embodiments are intended as illustrations, and not limitations, of several aspects of the technology. Any equivalent embodiments are intended to be within the scope of this technology. Indeed, various modifications of the technology in addition to those shown and described herein will become apparent to those skilled in the art from the foregoing description. Such modifications are also intended to fall within the scope of the appended claims.

What is claimed is:

1. A system for measuring a cleave angle of an optical fiber, the system comprising:
a light source configured to emit light;
an optical fiber having a proximal tip, a distal tip, and a longitudinal axis, wherein the optical fiber is configured to receive the light emitted by the light source at the proximal tip and to emit characterization light from the distal tip;
a first camera facing toward the optical fiber, wherein the first camera is configured to measure a first position of the distal tip and a first angle corresponding to the longitudinal axis;
a second camera facing toward the optical fiber, wherein the second camera is configured to measure a second position of the distal tip and a second angle corresponding to the longitudinal axis; and
a position sensing device operable to measure the characterization light emitted from the distal tip.

2. The system of claim 1, wherein the first camera is disposed along a direction that is orthogonal to the longitudinal axis.

3. The system of claim 2, wherein the second camera is disposed along a direction that is orthogonal to the longitudinal axis.

4. The system of claim 1, wherein the first camera and the second camera are disposed in directions that are orthogonal to the longitudinal axis and the first camera is disposed along a direction that is orthogonal to the second camera.

5. The system of claim 1, further comprising a first backlight disposed opposite the first camera and operable to illuminate at least the distal tip of the optical fiber.

6. The system of claim 1, further comprising a second backlight disposed opposite the second camera and operable to illuminate at least the distal tip of the optical fiber.

7. The system of claim 1, further comprising an optical fiber chuck configured to support the optical fiber.

8. The system of claim 7, wherein the optical fiber chuck comprises a mechanical clamp or a vacuum clamp.

9. A method for measuring a cleave angle of an optical fiber, the method comprising:
providing an optical fiber having a longitudinal axis and a distal tip characterized by a cleave angle;
imaging the distal tip of the optical fiber;
determining, based on the imaging, a pose of the distal tip of the optical fiber;
emitting light from a light source, wherein the optical fiber is configured to receive the light emitted by the light source;
emitting characterization light from the distal tip of the optical fiber;
detecting, at an image sensor, the characterization light; and
determining, based on the characterization light and the pose of the distal tip of the optical fiber, the cleave angle of the optical fiber.

10. The method of claim 9, further comprising an optical fiber chuck configured to support the optical fiber.

11. The method of claim 10, wherein determining the pose of the optical fiber includes translating the optical fiber chuck and the optical fiber along the longitudinal axis.

12. The method of claim 11, wherein translating comprises displacing the optical fiber along the longitudinal axis.

13. The method of claim 9, wherein the pose of the distal tip of the optical fiber includes a position and angle.

14. The method of claim 9, wherein the imaging is performed by a first camera and a second camera, the first camera and the second camera being disposed in directions that are orthogonal to the longitudinal axis.

15. The method of claim 14, wherein the first camera measures a first position of the distal tip and a first angle corresponding to the longitudinal axis.

16. The method of claim 14, wherein the second camera measures a second position of the distal tip and a second angle corresponding to the longitudinal axis.

17. The method of claim 14, wherein the first camera is disposed along a direction that is orthogonal to the second camera.

18. The method of claim 9, wherein detecting, at the image sensor, the characterization light includes determining a position of the characterization light.

19. The method of claim 14, further comprising illuminating the distal tip via a first backlight disposed opposite the first camera and a second backlight disposed opposite the second camera.

20. A system for measuring a cleave angle of an optical fiber, the system comprising:
a light source configured to emit light;
an optical fiber having a proximal tip, a distal tip, and a longitudinal axis, wherein the optical fiber is configured to receive the light emitted by the light source at the proximal tip and to emit characterization light from the distal tip;
a multi-stage axis configured to support the optical fiber and translate the optical fiber is a first direction and/or a second direction;
a first camera facing toward the optical fiber, wherein the first camera is configured to measure a first position of the distal tip and a first angle corresponding to the longitudinal axis;
a second camera facing toward the optical fiber, wherein the second camera is configured to measure a second position of the distal tip and a second angle corresponding to the longitudinal axis; and
a position sensing device operable to measure the characterization light emitted from the distal tip.
